(19) United States
(12) Patent Application Publication
(10) Pub. No.: US 2005/0098617 A1
(43) Pub. Date: May 12, 2005

(54) Message communication device and method for postal applications

(76) Inventor: Janice K. Woodson, Santa Clarita, CA (US)

Correspondence Address: LAW OFFICES OF DAVID L. HOFFMAN, 27023 MCBEAN PKWY, SUITE 422, VALENCIA, CA, 91355, US

(21) Appl. No.: 10/984,138

(22) Filed: Nov. 8, 2004

Related U.S. Application Data
(60) Provisional application No. 60/518,430, filed on Nov. 6, 2003.

(51) Int. Cl. B65D 91/00; G09F 7/04

(52) U.S. Cl. 232/33; 40/600

(57) ABSTRACT

A writing member or message device has a fixed message and/or fixed message template therein, and/or blank message, and has an adhesive, magnetic or hook and loop attachment region and a message writing material with the fixed message or message template thereon, and/or blank message thereon. In a preferred embodiment, the message region is a writable plastic material or other surface on which one may write which is easily erasable, whether marker or other writing implement. However, any writable surface or just imprinted surface is acceptable in other embodiments. In a further embodiment, the device has a base attached to the mailbox and a detachable portion for attachment and removal from the base, as needed, and which portion has a message writing material. The device in various embodiments is thin, and preferably planar, and preferably on the order of no more than a few inches long and/or wide, thus being positionable on virtually any type of mailbox, inside or outside. In a further embodiment, there is preferably a set of devices having various fixed messages and/or fixed message templates, and preferably a blank template, of common messages to the letter carrier. A method of providing a message to a letter carrier includes a step of selecting a message, completing the message if needed, and attaching the message device to the mailbox.

### CROSS-REFERENCE TO RELATED APPLICATIONS

This application is related to and claims priority from U.S. Provisional Patent Application Ser. No. 60/518,430 filed Nov. 6, 2003, incorporated by reference herein.

### BACKGROUND OF THE INVENTION

1. Field of the Invention

The invention relates to a message communication device and method for postal application.

2. Description of the Related Art

Communication between a letter carrier and a customer originated by the customer has long been carried out by forms or cards mailed to the Post Office, such as for hold mail or forward mail, or simply writing on mail itself, e.g., writing “please forward” on mail inadvertently left in the customer's mailbox. Sometimes there is communication by way of notes left on the door or at the mailbox. These methods of communicating can still result in missed communication and therefore wasted effort and/or delayed delivery of mail. In addition, weather or outdoor conditions such as wind, rain, sleet, hail, and dew can destroy a message.

A flag has been used for a long time to indicate mail delivery and/or outgoing mail. The flag can sometimes be left in the wrong position and therefore give the wrong message. In addition, it is sometimes confusing as to what the flag means.

A number of devices to communicate with the letter carrier have been developed. In U.S. Pat. No. 5,388,759 to Barnes discloses a device that attaches to the outside of the door of a metal typical rural mailbox. The device has a shutter-like sign area which displays either a “MAIL” or “NO MAIL” message. This device is large, can be obtrusive and has very limited message capability.

In U.S. Pat. No. 4,291,342 to O'Connor, a portable cassette player is installed in a mailbox to play a message when the box is opened.

In U.S. Pat. No. 5,323,959 to Draper, indicia such as the addressee's name may be displayed on top of the mailbox. A triangular device sits atop the mailbox, and a hook and loop fastening system is used to attach and de-attach a panel having the indicia. Alternatively, adhesive pads may be used to attach the panel. The triangular device also provides a receptacle for a newspaper or other articles. This device and many of the other devices are cumbersome to use, subject to the weather, expensive to make, and difficult to attach to all types of mailboxes, especially when the boxes are ganged or clustered as is now popular, or are in a bank of mailboxes, such as typical postal boxes, apartment mailboxes, and private mailbox service centers. In addition, the number of different messages that can be provided to the carrier are limited in these devices.

Postal regulations and/or other governing laws and/or rules typically prohibit placing devices and other things inside the mailbox, other than mail. What is needed is a device that can readily attach universally to almost any mailbox exterior, or attach to the interior without getting in the letter carrier's way and may thus be acceptable to the carrier. A device that can readily provide multiple messages to select from is also needed.

In spite of prior message systems, what is further needed is a quick, easy, low cost, and reliable communication system to communicate with the letter carrier.

### SUMMARY OF THE INVENTION

In one embodiment, the present invention is a writing member with a fixed message and/or fixed message template therein, thus comprising an adhesive, magnetic or hook and loop attachment region and a message writing material with the fixed message or message template thereon.

In another embodiment, the message region is blank. In a preferred embodiment, the message region is a writable plastic material or other surface on which one may write which is easily erasable, whether marker or other writing implement. However, any writable surface or just imprinted surface is acceptable in other embodiments.

In a further embodiment, the device has a base attached to the mailbox and a detachable portion for attachment and removal from the base, as needed, and which portion has a message writing material. The device in various embodiments is thin, and preferably planar, and preferably on the order of no more than a few inches long and/or wide, thus being able to be positioned on virtually any type of mailbox, inside or outside.

In a further embodiment, there is preferably a set of devices having various fixed messages and/or fixed message templates, and preferably a blank template, of common messages to the letter carrier. In a further embodiment, a method according to the invention includes a step of selecting a message, completing the message if needed, and attaching the message device to the mailbox.

The present inventor has recognized that there are several fixed messages and several message templates that are useful to an addressee, and has grouped those fixed messages and message templates.

A type of magnet that is preferred for its quality and endurance is known as a button magnet manufactured by California Button Company of Santa Fe Spring, Calif. The various embodiments of the invention help insure accurate messages and therefore accurate mail delivery and pickup services.

### BRIEF DESCRIPTION OF THE DRAWINGS

FIG. 1 is a perspective view of an open mailbox of a first type with a message device in accordance with a first embodiment of the invention;

FIG. 2 is a perspective view of a mailbox of a second type with a message device in accordance with a second embodiment of the invention;

FIG. 3 is a perspective view of an open mailbox of a third type in a cluster of mailboxes with a message device in accordance with the second embodiment;

FIG. 4 is a flow chart of steps in a process in accordance with a third embodiment of the invention;

FIG. 5 is a sectional view of the message device of FIG. 1;

FIG. 6 is a sectional view of the message device of FIG. 2;

FIG. 7 is a sectional view of the message device of FIG. 3;

FIG. 8 is a sectional view of a message device according to a fourth embodiment of the invention;

FIG. 9 is a view similar to FIG. 8 but of a fifth embodiment;

FIG. 10 is a perspective view of a mailbox of a fourth type with a message device in accordance with the invention attached thereto; and

FIG. 11 is a schematic view of the front of a set of message devices in accordance with one embodiment of the invention.

### DESCRIPTION OF THE PREFERRED EMBODIMENT(S)

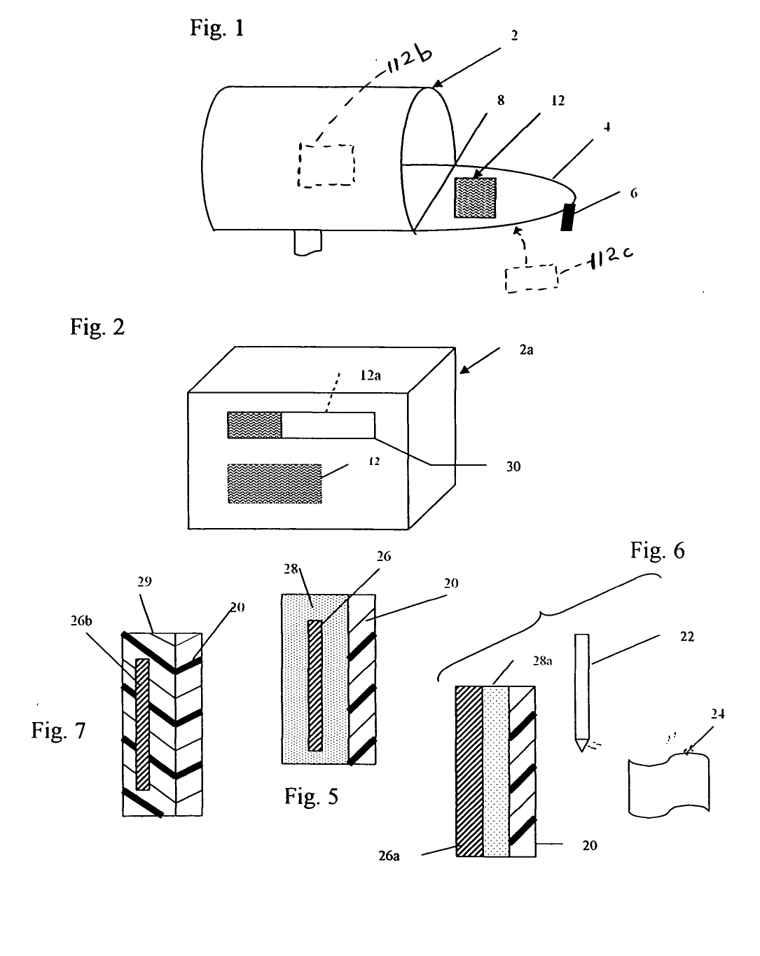

FIG. 1 shows a mailbox 2 with a front opening panel 4 that opens by pulling forward on handle 6. Panel 4 is attached to box 2 by a hinge 8 or hinges, and usually is press fitted in the closed position. Mail is placed inside box 2 and removed from box 2 by opening door 4. Typically, box 2 is all or substantially all, or primarily metal. In any event, at least door 4 or part thereof or at least the remainder of box 2 or part thereof is metal.

A message device 12 according to a first embodiment of the invention is shown attached to the inside wall of mailbox 2, and in particular the inside of panel 4 (the door). It may also be attached elsewhere inside mailbox 2 but the door is probably the easiest for the letter carrier to see. This type of mailbox is usually metal, so a message device 12 of a magnetic type, such as shown in FIGS. 5-7, is preferred. The device may also be attached to the outside of door 4, such as shown by device 112c or to the outside of the mailbox such as shown by device 112b.

The device of FIG. 5 has a writable surface 20, preferably, e.g., of a plastic layer such as the type that is easily written on by a marker, e.g., marker 22, and easily erased by a cloth, e.g., cloth 24, and also not damaged by weather or the elements. The device also preferably has a magnetic element 26, 26a, or 26b (a magnet, magnets or magnetic material) affixed to the writable surface 20 by adhesive material 28 or 28a or by embedding in plastic 29, which adheres to the writable surface 20. Other variations are possible.

In FIG. 2, message device 12 is adhered to an outer surface of a mailbox 2a, which is a type where letters are passed through a swinging plate 30. Alternatively, the message device is made of a size suitable to fit on or on the inside of the swinging plate 30, such a message device being indicated by dashed element 12a.

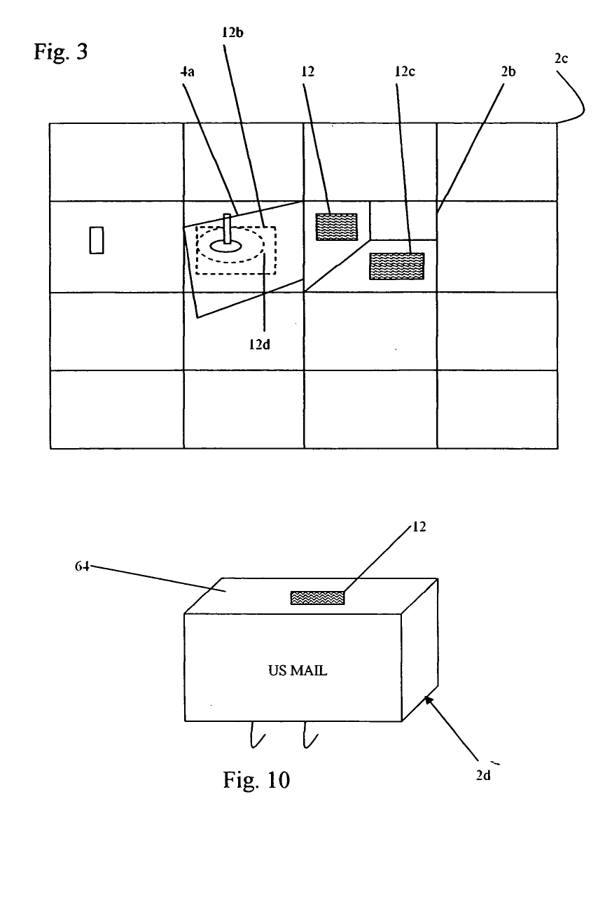

In FIG. 3, message device 12 is shown on the inside wall of a mailbox 2b in a group of boxes 2c, typically requiring a key to be opened by the user and letter carrier. Sometimes the letter carrier can open all of the boxes 2c in the group at the same time. In any event, the user may place a message device 12c on the floor of the box 2b or a message device 12b on its door 4a, preferably on the inside of the door. The lock hardware may interfere with placement on the door, so the message device could be made with a hole 12d or recess in it to accommodate the lock hardware.

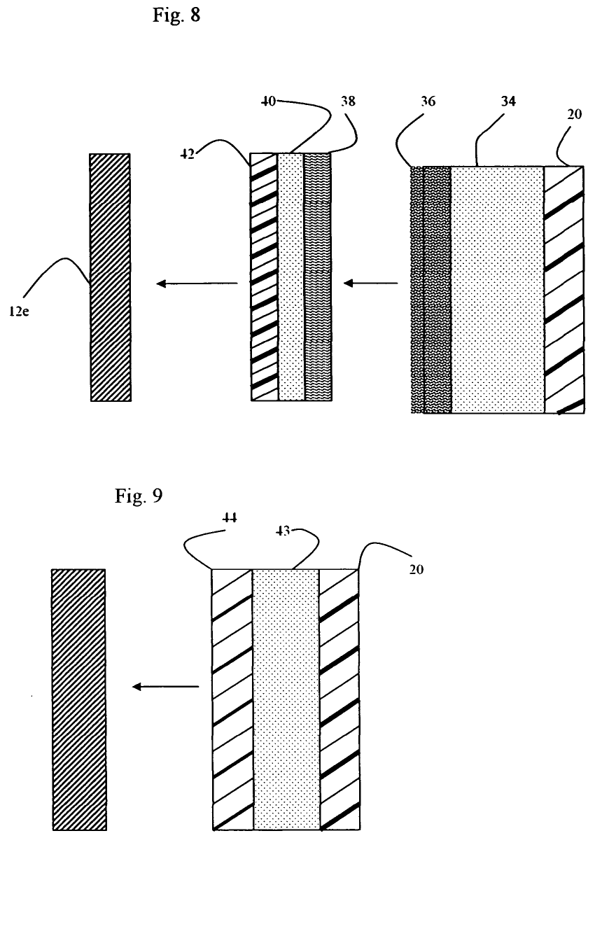

The message device may also be of a type as is shown in FIG. 8, which has or makes use of hook and loop fasteners such as known by the Trademark VELCRO®, e.g., made by Velcro USA, Inc. Surface 20 may be attached by adhesive 34 to a loop (or hook) fastener element 36, and a hook (or loop) fastener layer 38 may be attached, e.g., by adhesive 40 to a peelable, e.g., plastic or wax layer 42. In use, the layer 42 would be peeled from the adhesive 40, and the adhesive 40 would be attached to the mailbox, such as mailbox 12e, such as at any of the places shown in other embodiments, or other desired places on the mailbox. Then, the message device may be attached by the fastener element 36 being placed against the fastener layer 38. In a preferred embodiment, a message device may be of the magnetic type constructed as explained herein, and may be sold or packaged with hook and loop fasteners and/or adhesive fasteners too. The hook and loop fasteners would have an adhesive backing with a peelable cover, so that one or more hook (or loop) fasteners could be attached to the back of the device, and one or more corresponding loop (or hook) fasteners could be attached to the mailbox in the desired location. Similarly, the adhesive fasteners could be double sided with peelable backing on each side, and if it is desired to be used, can be attached to the back of the device, and then used to attach to the mailbox.

Accordingly, one or more message devices 20 can be attached to layer 38 and removed, as desired, so as to accommodate multiple messages or so as to accommodate placing and removing one message.

In FIG. 9, a writable layer 20 has an adhesive layer 43 having a peelable backing member 44. The adhesive layer 43 may be permanent or removable, such as the type used in reusable note paper such as known under the trademark POST-IT® Notes made by 3M, also known as Minnesota Mining and Manufacturing, Inc., of St. Paul, Minn.

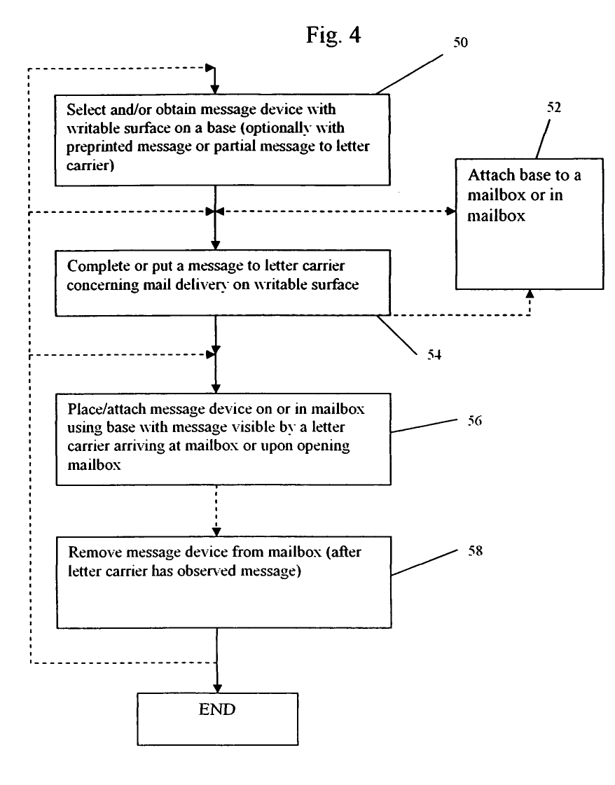

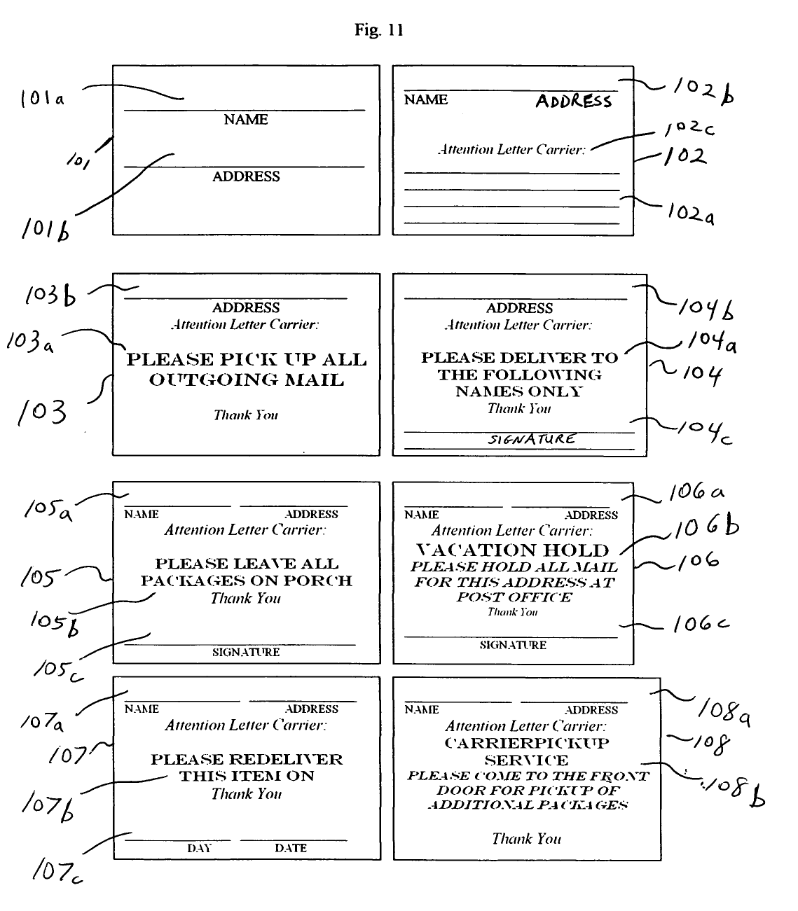

A method according to the invention is shown in FIG. 4. There may be multiple message devices optionally with a preprinted message thereon or having a preprinted partial message to be completed by the user, or blank or blanks to be completed by the user. The message is one for the letter carrier, such as noted above. Messages, (e.g. “attention letter carrier”) may include, for example, a general message to be completed by the user; it may be a blank for the user's name and address; it may be a notice to hold mail such as during the user's vacation, which may or may not have a place for a signature by the user; and/or it may be a message to leave packages in a particular area, which may or may not be signed by the user and it may be a message to, e.g., “pick up all outgoing mail”, which may or may not be signed by the user. Other appropriate messages may be used. Examples of some messages are shown in FIG. 11, which is a set of common messages and common message templates, along with a blank message template. The user selects the desired message, and if needed, writes any necessary information in blanks provided on the message templates. The user puts the message on the mailbox or in it.

The user may have one message device or multiple devices with various messages, such as some or all of those discussed above, printed on them. The user obtains and selects the appropriate message device, writes on the writable surface as needed or desired, as represented by step 50. At anytime the user may attach a base plate to the mailbox (e.g., a metal plate if the mailbox or a portion thereof does not contain metal and the device is magnetic), as shown by step 52. Instead of attaching metal, the user may attach a hook or loop fastener member 38, such as shown in FIG. 8, to the mailbox. At anytime the user may complete the message or put a message to the carrier concerning the mail delivery on the writable surface, as shown by step 54. The user may, at any time, e.g., before or after this step place or attach the message device on or in the mailbox using the magnetic base or other attachment means, preferably with the message visible by a letter carrier arriving at the mailbox or upon a letter carrier opening the mailbox, as shown by step 56. Optionally, at step 58, the user may remove the message device from the mailbox, e.g., after the letter carrier has observed the message or after it has served its usefulness or as otherwise desired by the user. The user may then select another message device or reattach the same message device and proceed through the steps in FIG. 4 again or only the steps as needed.

FIG. 10 shows a mailbox 2d of a fourth type with message device 12 on lid 64, which is hinged to the rest of the box. The message device can also be placed on the front, or inside of the lid or inside the box, such as on the back wall. The message device can also be used on a metal mail door slot by placing it on the outside or inside.

While the dimensions of the device can be virtually anything that would reasonably fit on or in the user's mailbox, preferred dimensions are two to four inches, with the width and length being anywhere in these amounts, and preferably being two inches by four inches or one and three quarter inches by three and three quarter inches. A suitable thickness may again be any reasonable thickness to attach on or in the mailbox, and preferably is about 1/16 of an inch to about ⅛ of an inch.

As noted above, the backing material may be a magnetic material, a hook and loop fastener, or any other reasonable attachment method which is readily removable and attachable. It is also possible to have only a portion of the backing be adhesive in the adhesive embodiment of FIG. 9.

FIG. 11 shows a set of message devices in accordance with one embodiment of the invention, where there are fixed message templates, 103-108 each having a fixed message 103a, 104a, 105b, 106b, 107b and 108b, respectively, and there may also be address or name and address blanks 103b, 104b, 105a, 106a, 107a and 108a, respectively, signature blanks 104c, 105c, 106c and 107c, and day and date blanks 107c. There may also be a blank template 102, or templates, which provides blanks 102a for writing in a message and/or contain a partial message 102c, and/or have a name and address blank 102b. Template 101 has blank spaces 101a for name and 101b for address.

Although the invention has been described using specific terms, devices, and/or methods, such description is for illustrative purposes of the preferred embodiment(s) only. Changes may be made to the preferred embodiment(s) by those of ordinary skill in the art without departing from the scope of the present invention, which is set forth in the following claims. In addition, it should be understood that aspects of the preferred embodiment(s) generally may be interchanged in whole or in part.

1. A method for attaching to a mailbox a notification to a letter carrier, the method comprising the steps of:
selecting a message device having a writable surface;
attaching the device to a mailbox with the writable surface facing away from the surface attached to the mailbox;
providing a message on the writable surface relating to mail services; and
removing the message device.

2. The method for attaching as recited in claim 1, wherein in the step of attaching, the device is attached inside the mailbox.

3. The method for attaching as recited in claim 1, wherein in the step of attaching, the device is attached outside the mailbox.

4. The method for attaching as recited in claim 1, wherein in the step of attaching, the device is attached to an inside of a door of the mailbox.

5. The method for attaching as recited in claim 1, wherein in the step of selecting, the device is selected from a group of devices having a message template with a predetermined message and a place to write a portion of a message.

6. The method for attaching as recited in claim 5, wherein there is a step of writing a message or portion of a message on the template.

7. The method for attaching as recited in claim 5, wherein in the step of selecting, the device is selected from a group of devices having a message template with a predetermined message and a place to write a portion of a message.

8. A message device for attaching to a mailbox a notification to a letter carrier, the device comprising:
a writable surface;
an attachment mechanism to attach the device to a mailbox, the attachment mechanism being selected from a group comprising at least one of magnetic material, adhesive material, and hook and loop fastening material.

9. The message device of claim 8, wherein the writable surface comprises a plastic material.

10. The message device of claim 8, having a width and length, each being anywhere between and inclusive of two to four inches.

11. The message device of claim 8, having a length of three to four inches inclusive, and a width of one and three quarter inches to two inches, inclusive.

12. The message device of claim 8, having a thickness between about 1/16 of an inch and about ⅛ of an inch, inclusive.

13. The message device of claim 12, having a width and length, each being anywhere between and inclusive of two to four inches.

14. The message device of claim 12, having a width and length, each being anywhere between one and three quarter inches and two inches, inclusive.

15. A combination mailbox and a message device for attaching to the mailbox to provide a notification to a letter carrier, the combination comprising:
a mailbox;
a writable surface; and
an attachment mechanism to attach the device to a mailbox, the attachment mechanism being selected from a group comprising at least one of magnetic material, adhesive material, and hook and loop fastening material.

16. The message device of claim 15, wherein the writable surface comprises a plastic material.

17. The combination mailbox and a message device of claim 15, wherein the device has a width and length, each being anywhere between and inclusive of two to four inches.

18. The combination mailbox and a message device of claim 15, wherein the device has a width and length, each being anywhere between and inclusive of one and three quarter inches and three inches.

19. The combination mailbox and message device of claim 15, wherein the device has a thickness between about 1/16 of an inch and about ⅛ of an inch, inclusive.

20. The combination mailbox and message device of claim 15, wherein the device is attached to the inside of the mailbox door.
